(19) United States
(12) Patent Application Publication
(10) Pub. No.: US 2006/0090071 A1
(43) Pub. Date: Apr. 27, 2006

(54) Systems and methods for project management

(76) Inventors: Werner Sinzig, Nussloch (DE); Rene Lamade, St. Leon-Rot (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/248,159

(22) Filed: Oct. 13, 2005

Related U.S. Application Data
(60) Provisional application No. 60/618,905, filed on Oct. 13, 2004.

(51) Int. Cl. H04L 9/00

(52) U.S. Cl. 713/166

(57) ABSTRACT

Methods, systems, and computer program products are provided for managing a project. In one implementation, a system is provided that comprises a set of data sources for providing project management data and project management tools, and a server computer that is coupled to the set of data sources. The server may be operable for dynamic generation of a user specific web page for providing a user interface to the project management data and project management tools. The web page may comprise at least a first portion for entry and/or display of a project plan, the project plan comprising a plurality of tasks, a second portion for entry and/or display of icons representative of documents and/or document templates, each document and/or document template being assigned to at least one of the tasks, and a third portion for providing access to an inter-user communication tool.

### CROSS REFERENCE TO RELATED APPLICATIONS

The present application claims priority under 35 U.S.C. § 119 to U.S. Provisional Patent Application No. 60/618,905, filed on Oct. 13, 2004, which is expressly incorporated herein by reference in its entirety.

### FIELD OF THE INVENTION

The present invention generally relates to the field of data processing systems and related methods. More particularly, and without limitation, the invention relates to computer-implemented systems and methods for managing a project.

### BACKGROUND OF THE INVENTION

Good project management is an important factor to the success of a project. A project may be thought of as a collection of activities and tasks designed to achieve a specific goal of the organization, with specific performance or quality requirements while meeting any subject time and cost constraints. Project management refers to managing the activities that lead to the successful completion of a project. Project management focuses on finite deadlines and objectives. A number of tools may be used to assist with project management and assessment.

One of the more commonly used software packages for project schedule management is Microsoft Project. Microsoft Project allows for task data, such as duration, start date, finish date, and resources to be entered. As the project advances, information on actual performance may be entered, as well as information may be developed and presented concerning the performance of the project to date.

Importantly, the cost of information processing not only includes the cost of computer hardware and software, but perhaps even more significantly, the cost of human resources devoted to gathering and processing information using computer systems. Improvements to the usability of computer hardware and software reduce the cost of human resources associated with information processing, either by reducing the amount of time directly devoted to a particular task by a human operator (user), or by reducing the level of training required of a user in order to achieve proficiency in performing the task. Continued progress of the information revolution requires still further improvements to the usability of computer systems.

Graphical user interfaces (GUIs) have become standard user interfaces for a variety of software applications, including project planning software. Among the standard features of such GUIs are selectable icons for performing an action, such as toolbars, pull-down menus, and the like which offer selections to the user. A common characteristic of all these is that the user may select one action from among multiple actions offered using a pointing-device or similar input, without having to type in the name of an action. In theory, this frees the user from the need to remember commands or other selection identifiers.

Generic GUI interfaces are adequate for many applications where the number of tasks that a user must perform are few and the type of application is limited in scope. However, where complexity increases, even the “prompting” provided by GUI interfaces may be inadequate. This is particularly true in the case of processes which involve contributions from a set of multiple individuals, where each individual or group of individuals in the set supports a different part of the overall process. The set may be, for example, all the employees in a particular commercial enterprise, or, for a large enterprise, would more typically be a subset of the employees involved in some particular project or aspect of the company's business which shares common data.

Where different individuals in a set use common data to support some process or processes, there is a tendency to employ a software interface broad enough to cover all individuals in the set. Such a generic GUI will have toolbars, menus, and other task selections sufficient to cover the requirements of all individuals. However, most if not all of the individual users use only a portion of the array of task selections available. Therefore, any particular user is typically presented with a large number of task selections which he does not use, although other users may need those selections. This makes the number of selections unduly large, and creates confusion and annoyance among the users. In order to reduce the apparent complexity, some software designers combine different but related task selections into a single generic selection, which may be followed by a menu of options. However, this also has possible adverse ramifications, as the users might have difficulty understanding the correct generic task designation required to reach the actions they want, and the requirement of an options menu may slow user input. Another problem encountered with such generic GUIs is that individual user groups within the set of users may have specialized vocabulary for identifying particular tasks, so that the generic language used to identify a task selection may be difficult for some users to understand.

It is possible to address the problems mentioned above by writing customized software applications for each group of users, or by writing a single customized software application which treats each user group differently and presents different user interfaces, involving different selections, to each group of users. Writing such customized software may consume enormous programming resources.

There is, therefore, a need for an improved data processing system for managing a project.

### SUMMARY OF THE INVENTION

In accordance with embodiments of the present invention, data processing systems are provided for managing a project. The data processing system may comprise a set of data sources for providing project management data and project management tools, and a server computer coupled to the set of data sources. The server computer may be operable for dynamic generation of a user specific web page for providing a user interface to the project management data and project management tools. The web page may comprise at least a first portion for entry and/or display of a project plan, the project plan comprising a plurality of tasks, a second portion for entry and/or display of icons representative of documents and/or document templates, each document and/or document template being assigned to at least one of the tasks, and a third portion for providing access to an inter-user communication tool.

Advantageously, embodiments of the present invention, may facilitate the collaboration of various users for managing a project. For example, this may be accomplished by dynamic generation of web pages for the users in order to provide respective user interfaces. Each web page provides a user-specific view on the project in accordance with the user's role which greatly facilitates the user's interaction with the system. The web page may provide an integrated view on both the project plan, the documents and/or document templates required for execution of tasks of the project plan, as well as an inter-user communication tool, such as an e-mail tool and/or chat room functionality.

In one embodiment, each of the user specific web pages enables the respective user to perform various actions with respect to the definition and/or performance of project tasks. For example, a user specific web page may provide various functionalities, such as writing an e-mail to a specific user, a group of users or all users, creation or selection of a template for the performance of various tasks, assignment of attributes to selected templates, assignment of documents to users or tasks, such as by drag-and-drop, consolidation of documents, transfer of data, documents and/or links to a data warehouse, sending of meeting requests, etc. These tools may facilitate a collaborative approach. For example, an initiator of a project management project sets global tasks and time limits that are subsequently refined as the project develops.

In accordance with another embodiment of the present invention, the data processing system includes a repository that contains a declaration of the variables that are used for the performance of the project management in terms of semantics, data type, data structure, etc. In other words, the repository may provide a semantic network that is consistently used in the various documents that are created and processed for the performance of the project management tasks. The usage of such a semantic network facilitates the aggregation of values, such as for consolidation of documents. Further, these variables are also used as attributes that may be assigned to documents or templates.

In accordance with yet another embodiment of the invention, various data sources may be used for providing the project management data and the project management tools. For example, an enterprise resource planning system, project planning system, knowledge management system, data warehouse, and/or e-mail system may be used as such data sources. These data sources are selected and combined by the server computer for dynamic generation of the user-specific web pages.

In accordance with a further embodiment of the present invention, the project plan comprises roles that are assigned to users. Preferably, each role defines a sub-set of the available data that is used for generation of the respective user-specific web page. Furthermore, the roles may also define specific sub-sets of users for the inter-user communication. Likewise, the roles may specify sub-sets of documents and/or document templates that may be opened by a respective user and/or classes of tasks that may be accessed only by respective users. This selection of the data, that is used for generating a user-specific web page, reduces the amount of complexity of the interface and limits the data provided for read and/or write access to what is required for effective fulfilment of the respective user's role.

In accordance with an embodiment of the present invention, the inter-user communication tool is implemented as a chat room functionality. In such a case, the contributions of users to the chat room may be filtered. For example, a given user may only view contributions of other users that are within the scope as defined by the role that is assigned to that user. This may drastically reduce the amount of time a user has to spend on reading e-mail communications.

Embodiments of the present invention also relate to data processing methods of generating a web page. The method may comprise generating a first portion of the web page for entry and/or display of the project plan, the project plan having a plurality of tasks, generating a second portion of the web page for entry and/or display of icons representative of documents and/or document templates, wherein each document and/or document template is assigned to at least one of the tasks, and generating a third portion of the web page for providing access to an inter-user communication tool. Such methods may facilitate the generation of user-specific web pages for providing user-specific interfaces for a project management system.

Embodiments of the present invention also relate to computer program products comprising computer executable instructions for computer implementation of the data processing methods of generating a web page.

It is to be noted that the present invention is not limited to specific applications of project management, but that it is broadly applicable to any kind of project management activity, including budgeting, sales planning, planning of operating expenses, and other projects that require the contribution and collaboration of various kinds of users.

Additional objects and advantages of embodiments of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

In the following exemplary embodiments of the invention are described in greater detail by way of example only making reference to the drawings in which:

FIG. 1 illustrates an exemplary first user-specific web page showing a top-level view on the projects of a given user, consistent with an embodiment of the present invention;

FIG. 2 illustrates an exemplary user-specific web page that is generated for a selected project, consistent with an embodiment of the present invention;

FIG. 3 illustrates another exemplary user-specific web page for the selected project, consistent with an embodiment of the present invention;

FIG. 4 illustrates an exemplary user-specific web page showing the consolidation of documents, consistent with an embodiment of the present invention; and

FIG. 5 illustrates a block diagram of an exemplary data processing system, consistent with an embodiment of the present invention.

### DESCRIPTION OF THE EMBODIMENTS

Reference will now be made in detail to the present exemplary embodiments of the invention, examples of which are illustrated in the accompanying drawings. Wherever possible, the same reference numbers will be used throughout the drawings to refer to the same or like parts.

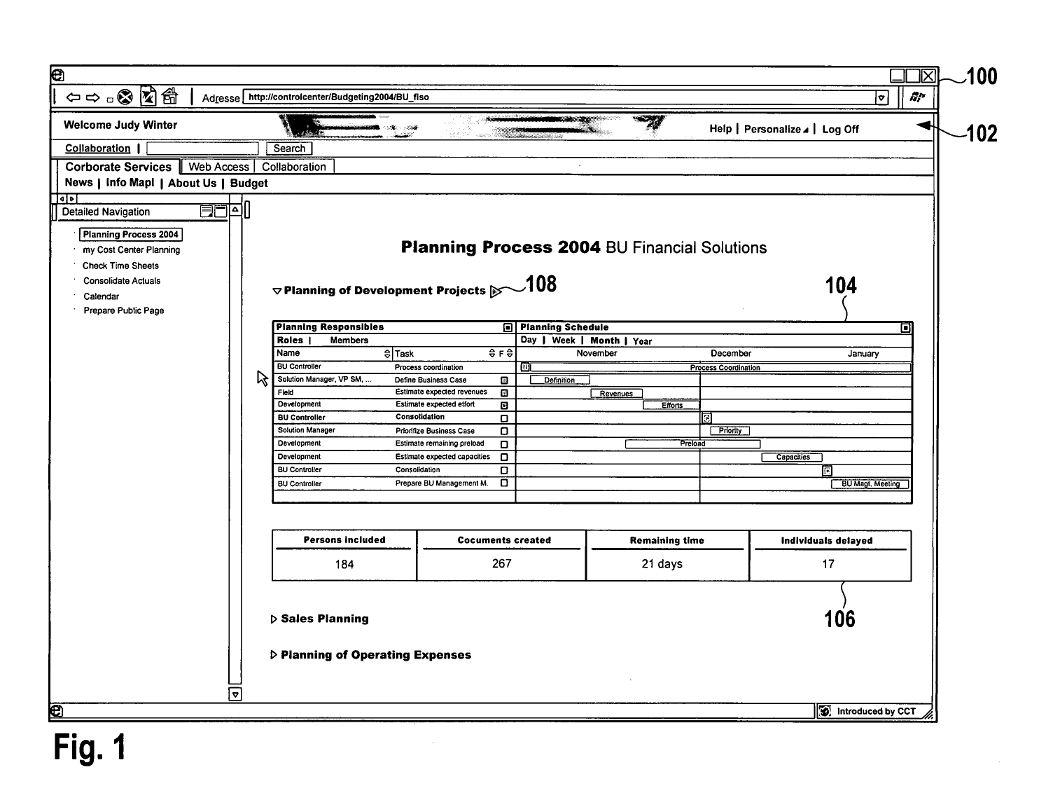

FIG. 1 shows a window 100 illustrating an exemplary user-specific web page 102 for a user “Judy Winter,” who is the controller of a business unit (BU). The web page 102 provides a top-level view on all projects in which Judy Winter is involved, i.e., the project “planning of development projects,” “sales planning,” and “planning of operation expenses.” By clicking on one of the projects, an expanded view is generated as shown in FIG. 1 for “planning of development projects.” In response to the selection of “planning of development projects,” the project plan 104 for this selected project is visualized on the web page 102, as well as matrix 106 that include various status and performance measurement values, such as “persons included,” “documents created,” “remaining time,” and “individuals delayed.” The project plan 104 shows users' names, as well as roles and tasks that are assigned to the users, and a time schedule for task fulfilment.

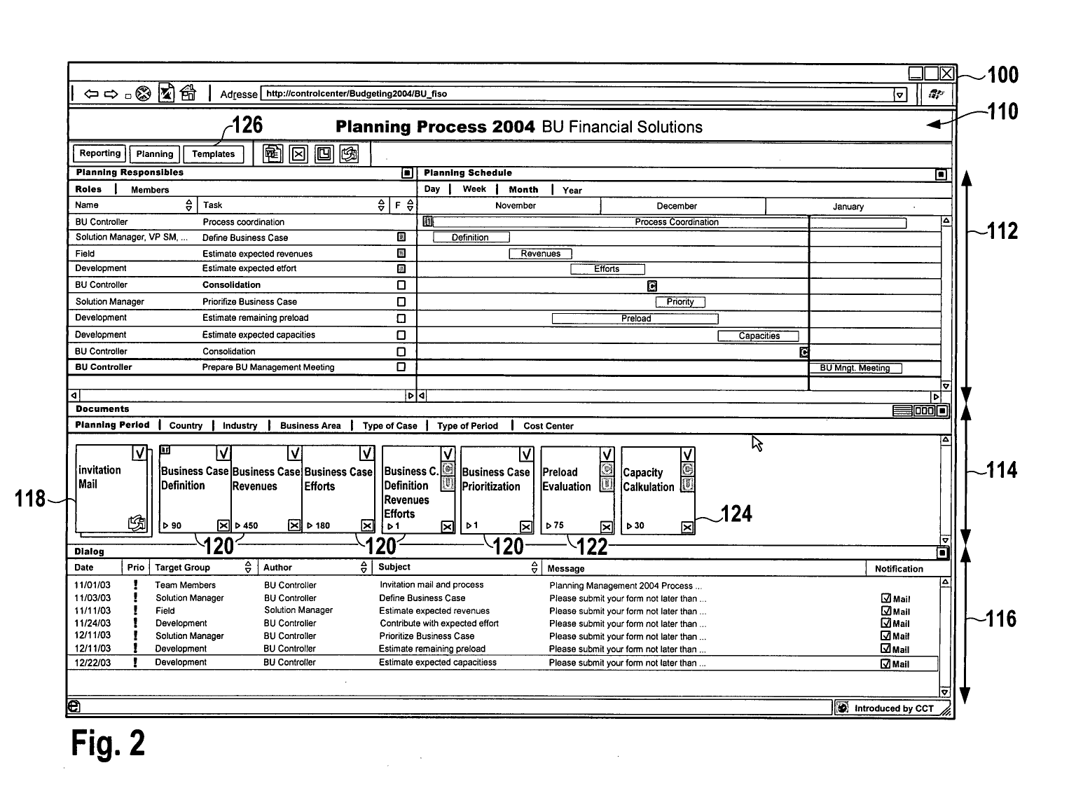

By clicking on an icon 108, next to “planning of development projects,” Judy Winter may request a more detailed interactive application of that project. This application is provided as web page 110 in the window 100 as shown in FIG. 2. The exemplary web page 110 has a portion 112 that shows the project plan 104, portion 114 that contains various icons being representative of documents and/or document templates, and portion 116 that provides access to an inter-user communication tool, such as a chat room.

The icons shown in the portion 114 include the following: icon 118 being representative of a document for generating an invitation mail to all team members, icons 120 that are related to a business case, including “definition,” “revenues,” “efforts,” “authorization,” “prioritization,” as well as a consolidated document containing “definitions, revenues, efforts.” Further, the portion 114 includes an icon 122 for “preload evaluation” and an icon 124 for “capacity calculation.” All icons 120, 122, and 124 have a check box for indication of a completion status. In the example considered here, all documents represented in the portion 114 have already been submitted such that the check boxes appear ticked. These documents are assigned to respective tasks identified in the planning schedule of the project plan shown on the portion 112, i.e., the document “business case definition” is assigned to the task “definition,” the document “business case revenues” is assigned to the task “revenues,” etc.

The portion 116 may provide access to messages from various users to certain target groups in sequential order.

In one embodiment, web page 110 enables access to all data without restriction as user “Judy Winter” has the role “BU controller” to which such access rights are assigned.

Advantageously, the web page 110 provides the user with a complete set of tools for performing various actions for the definition and/or performance of various process tasks. For example, Judy Winter may initiate the project by sending an “invitation mail” to all team members, select templates and assign templates to project tasks and/or project users, send email messages to specific users or groups of users, consolidate documents, and upload data to the data warehouse, etc.

For selection of a template, Judy Winter may click on the button 126 which provides access to a window for selection from a set of predefined templates. Judy Winter may select one of the templates and assign attributes to the selected template. Preferably, the attributes are selected from the repository as well as the attributes of respective tasks. Alternatively, or in addition, existing templates may be modified or additional templates may be created using the variables and attributes as defined in the repository.

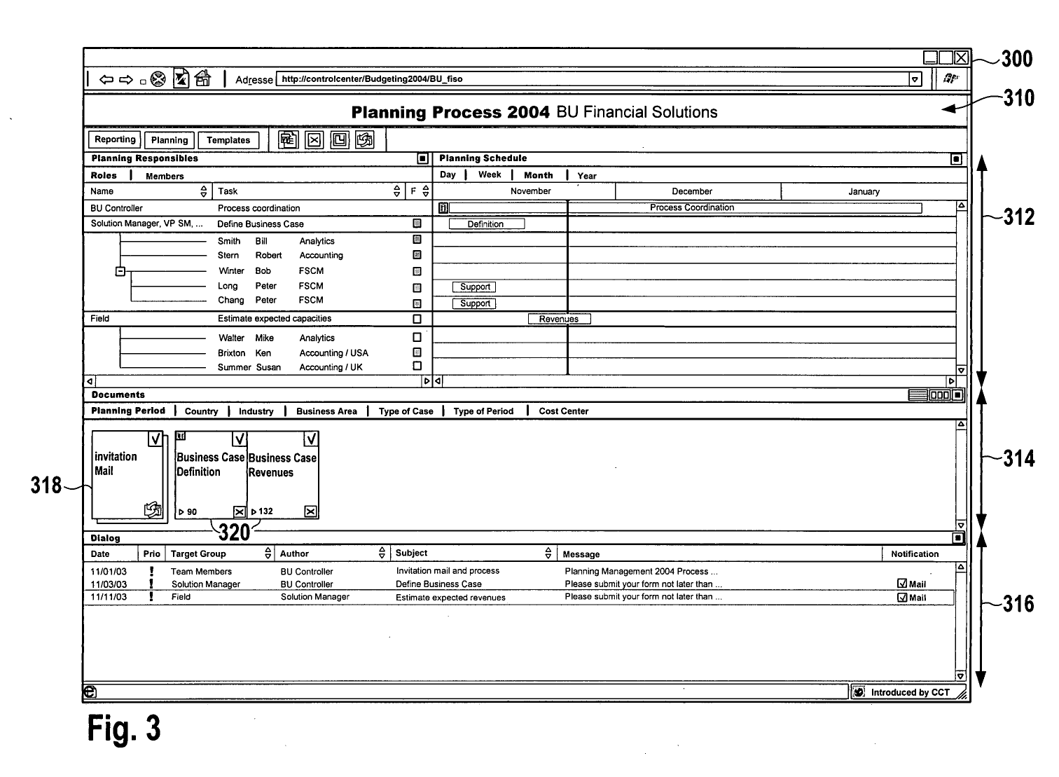

FIG. 3 shows a window 300 of another exemplary user-specific web-page that is displayed on a different user's computer. This user has a more specific role than Judy Winter and has therefore more limited access rights to the data that is used for the project management.

The window 300 contains a web page 310 that also has three portions 312, 314, and 316 analogous to the embodiments of FIG. 2. The version of the project plan 104 that is displayed in the portion 312 provides a more limited and specific view on the project plan that is of interest to the user in accordance with that user's role and respective access rights. Likewise, only a sub-set of the icons are shown in the portion 314, i.e., icons 318 and 320 as far as related to “business case definition” and “business case revenues” as the user that is considered here is not involved in “business case efforts,” “business case prioritization,” etc.

Likewise, only a sub-set of the messages exchanged between the users is made accessible in the portion 316 of the web page 310 for that user, again in accordance with this user's role and the respective access rights defined for that role. It is to be noted that the check box of the icon 120 that represents the document “Business case Revenues” appears unticked which indicates that completion of this document is on open task.

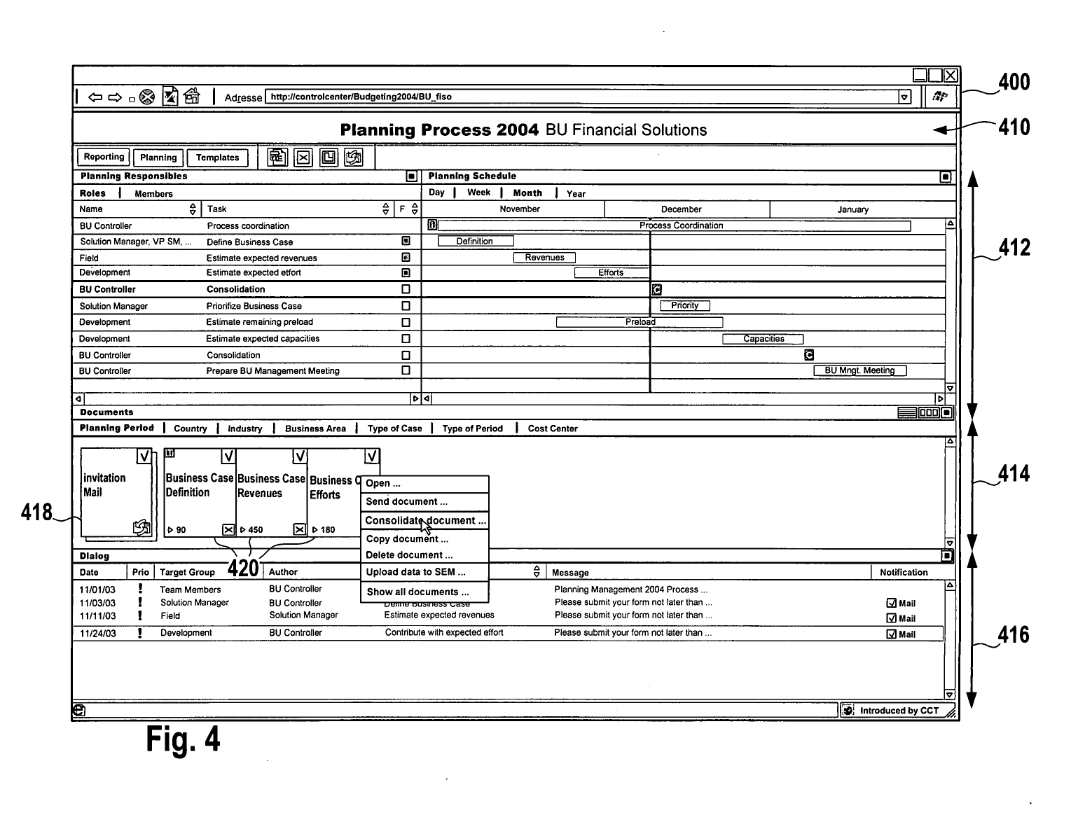

FIG. 4 shows a window 400 carrying another exemplary web page 410 of still another user. Again, the web page 410 has portions 412, 414, and 416 for showing a user-specific view on the project plan, a user-specific sub-set of the icons, and a user-specific sub-set of the messages exchanged between the users, respectively. By clicking on the right mouse button the user may select the functionality “consolidate document” in order to generate a consolidated document containing the inputs from the documents “business case definition,” “business case revenues” and “business case efforts.”

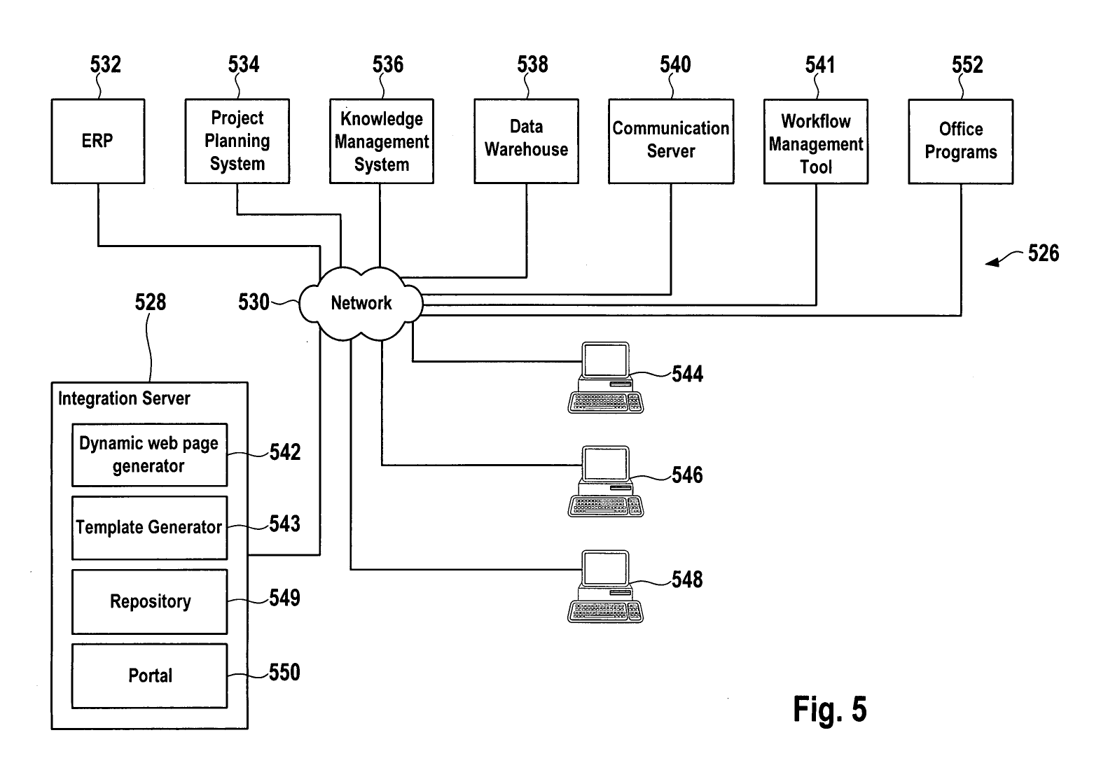

FIG. 5 shows a block diagram of an exemplary data processing system 526. The data processing system 526 includes an integration server computer 528 that is coupled to a network 530 for access to various data sources, such as an enterprise resource planning (ERP) system 532, a project planning system 534, a knowledge management system 536, a data warehouse 538, a communication server 540, a workflow management tool 541, and office programs 552, such as Microsoft Outlook, Word, Excel, PowerPoint, and/or Project. The integration server 528 includes a program component 542 that serves for extraction of data from the various data sources and usage of the tools implemented by the data sources, as well as for generating user-specific web pages, such as the web page 102 of FIG. 1, web page 110 of FIG. 2, web page 310 of FIG. 3, and web page 410 of FIG. 4. Further, the integration server 528 has a template generator 543, a repository 549 that may also be referred to as a data dictionary, and a portal 550 for access by the various users.

The repository 549 contains a declaration of the variables used in the data processing system in terms of semantics, data type, data structure, etc. As a consequence, the repository 549 provides a semantic network that is consistently used throughout the data processing system 526 and especially in the data warehouse 538.

The variables, such as “turnover,” “profit,” “quantity,” “name,” “address,” etc. that are declared in the repository 549 are also used by the template generator 543 and in the data warehouse 538. If a user invokes the template generator 543 for creation of a new document template, he or she may select from the variables declared in the repository. The selected variables are automatically mapped by the template generator 543 to the respective data entry fields in the newly created document template.

If a user fills out a respective document using such a document template, the values entered in the data entry fields are assigned to the respective variables that are mapped to the data entry fields. These values are stored in the data warehouse 538 for later reference, analysis, and/or aggregation.

In one embodiment, a link to the document from which these data values originate is also stored in the data warehouse. This enables a user of the data warehouse not only to view a value but also to conveniently access the document from which a value originates. If the value is an aggregate value, the link specifies a folder containing all documents that contributed to the calculation of the aggregate value, e.g., the documents represented by icons 420 in FIG. 4 that go into a consolidated document containing the aggregated value.

For example, the ERP system 532 serves to provide user master data, such as user names, user e-mail addresses, and the like. The project planning system 534 provides project plan data and/or a pre-generated view of the project plan for display in the respective portions 112, 312, and 412. The knowledge management system 536 serves for storage of documents and/or document templates as they are represented by the respective icons in the portions 114, 314, and 414. The data warehouse 538 may be used for extracting the matrix 106 (cf. FIG. 1). The communication server 540 implements an inter-user communication tool, such as a chat room functionality and/or a email and/or other kind of electronic messaging service. The workflow management tool 541 may be used to manage the flow of documents between the users and to show the completion status of documents, e.g., it generates a control signal that specifies whether an icon representing a document needs to appear ticked or unticked.

The network 530 may be a company's intranet or a virtual private network to which client computers 544, 546, and 548 of various users are coupled. Each of the client computer 544, 546, and 548 may include a web browser. By entering a specific URL into the web browser, the program component 542 on the integration server 528 is invoked for generating a user-specific web page for the respective user as illustrated in the preceding FIGS. 1 to 4, by way of example.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A data processing system for managing a project comprising:
a set of data sources for providing project management data and project management tools; and
a server computer coupled to the set of data sources and being operable for dynamic generation of a user specific web page for providing a user interface to the project management data and project management tools, wherein the web page comprises at least:
(a) a first portion for entry and/or display of a project plan comprising a plurality of tasks;
(b) a second portion for entry and/or display of icons representative of documents and/or document templates, each document and/or document template being assigned to at least one of the tasks; and
(c) a third portion for providing access to an inter-user communication tool.

2. The data processing system of claim 1, wherein the data sources are selected from the group comprising an enterprise resource planning system, a project planning system, a knowledge management system, a data warehouse system, and an e-mail system.

3. The data processing system of claim 1, wherein the project plan further comprises assigning roles to users.

4. The data processing system of claim 3, wherein each role defines a sub-set of the data provided by the data sources that is used for generation of the web page for a user to which the respective role is assigned.

5. The data processing system of claim 4, wherein only messages from a sub-set of users is made accessible on the third portion for the inter-user communication with the respective user.

6. The data processing system of claim 3, wherein each role specifies a sub-set of the documents and/or document templates and wherein the second portion only provides access to one of the sub-sets of documents and/or document templates.

7. The data processing system of claim 3, wherein each role specifies a class of tasks and wherein the first portion only provides access to one of the classes of tasks.

8. The data processing system of claim 1, wherein the third portion is adapted to provide access to a chat room functionality.

9. The data processing system of claim 1, wherein the project is a financial planning project.

10. The data processing system of claim 1, further comprising a repository for providing a semantic network.

11. A data processing method for generating a web page, the method comprising:
generating a first portion of the web page for entry and/or display of the project plan, the project plan having a plurality of tasks;
generating a second portion of the web page for entry and/or display of icons representative of documents and/or document templates, wherein each document and/or document template is assigned to at least one of the tasks; and
generating a third portion of the web page for providing access to an inter-user communication tool.

12. The data processing method of claim 11, wherein data for generating the first, second and/or third portions of the web page is received from a set of data sources for providing project management data and project management tools.

13. The data processing method of claim 12, wherein the data sources are selected from the group comprising an enterprise resource planning system, a project planning system, a knowledge management system, a data warehouse system, and an e-mail system.

14. The data processing method of claim 11, wherein the project plan further comprises roles being assigned to users, each role defining a sub-set of the data provided by the data sources that is used for generation of the web page for a user to which the respective role is assigned.

15. The data processing method of claim 14, wherein each role defines a sub-set of the users for the inter-user communication with the respective user to which the role is assigned.

16. The data processing method of claim 14, wherein each role specifies a sub-set of the documents and/or document templates and wherein the second portion only provides access to one of the sub-sets of documents and/or document templates.

17. The data processing method of claim 14, wherein each role specifies a class of tasks, wherein the first portion only provides access to one of the classes of tasks.

18. The data processing method of claim 14, wherein the third portion is adapted to provide access to a chat room functionality.

19. A computer program product, comprising executable instructions for performing a method of generating a web page, the method comprising:
generating a first portion of the web page for entry and/or display of the project plan, the project plan having a plurality of tasks;
generating a second portion of the web page for entry and/or display of icons representative of documents and/or document templates, wherein each document and/or document template is assigned to at least one of the tasks; and
generating a third portion of the web page for providing access to an inter-user communication tool.

20. The computer program product of claim 19, wherein data for generating the first, second and/or third portions of the web page is received from a set of data sources for providing project management data and project management tools.

21. The computer program product of claim 20, wherein the data sources are selected from the group comprising an enterprise resource planning system, a project planning system, a knowledge management system, a data warehouse system, and an e-mail system.

22. The computer program product of claim 19, wherein the project plan further comprises roles being assigned to users, each role defining a sub-set of the data provided by the data sources that is used for generation of the web page for a user to which the respective role is assigned.

23. The computer-program product of claim 22, wherein each role defines a sub-set of the users for the inter-user communication with the respective user to which the role is assigned.

24. The computer program product of claim 22, wherein each role specifies a sub-set of the documents and/or document templates and wherein the second portion only provides access to one of the sub-sets of documents and/or document templates.

25. The computer program product of claim 22, wherein each role specifies a class of tasks, wherein the first portion only provides access to one of the classes of tasks.

26. The computer program product of claim 22, wherein the third portion is adapted to provide access to a chat room functionality.
